(19) United States
(12) Patent Application Publication
(10) Pub. No.: US 2021/0383197 A1
(43) Pub. Date: Dec. 9, 2021

(54) ADAPTIVE STOCHASTIC LEARNING STATE COMPRESSION FOR FEDERATED LEARNING IN INFRASTRUCTURE DOMAINS

(71) Applicant: EMC IP Holding Company LLC, Hopkinton, MA (US)

(72) Inventors: Pablo Nascimento Da Silva, Niterói (BR); Paulo Abelha Ferreira, Rio de Janeiro (BR); Roberto Nery Stelling Neto, Rio de Janeiro (BR); Tiago Salviano Calmon, Rio de Janeiro (BR); Vinicius Michel Gottin, Rio de Janeiro (BR)

(21) Appl. No.: 16/892,746

(22) Filed: Jun. 4, 2020

(51) Int. Cl. G06N 3/04; G06N 3/063; G06K 9/62; G06F 17/14; G06N 3/08

(52) U.S. Cl. CPC G06N 3/0472; G06N 3/063; G06N 3/08; G06F 17/145; G06K 9/6223

(57) ABSTRACT

A method for adaptive stochastic learning state compression for federated learning in infrastructure domains. Specifically, the disclosed method introduces an adaptive data compressor directed to reducing the amount of information exchanged between nodes participating in the optimization of a shared machine learning model through federated learning. The adaptive data compressor may employ stochastic k-level quantization, and may include functionality to handle exceptions stemming from the detection of unbalanced and/or irregularly sized data.

### BACKGROUND

Through the framework of federated learning, a network-shared machine learning model may be trained using decentralized data stored on various client devices, in contrast to the traditional methodology of using centralized data maintained on a single, central device.

### SUMMARY

In general, in one aspect, the invention relates to a method for decentralized learning model optimization. The method includes receiving, by a client node and from a central node, a first learning model configured with an initial learning state, adjusting the initial learning state through optimization of the first learning model using local data to obtain a local data adjusted learning state, in response to receiving a learning state request from the central node, processing the local data adjusted learning state at least using stochastic k-level quantization to obtain a compressed local data adjusted learning state, and transmitting the compressed local data adjusted learning state to the central node.

In general, in one aspect, the invention relates to a non-transitory computer readable medium (CRM). The non-transitory CRM includes computer readable program code, which when executed by a computer processor on a client node, enables the computer processor to receive, from a central node, a first learning model configured with an initial learning state, adjust the initial learning state through optimization of the first learning model using local data to obtain a local data adjusted learning state, in response to receiving a learning state request from the central node, process the local data adjusted learning state at least using stochastic k-level quantization to obtain a compressed local data adjusted learning state, and transmit the compressed local data adjusted learning state to the central node.

Other aspects of the invention will be apparent from the following description and the appended claims.

### BRIEF DESCRIPTION OF DRAWINGS

FIG. 1A shows a system in accordance with one or more embodiments of the invention.

FIG. 1B shows a client node in accordance with one or more embodiments of the invention.

FIG. 1C shows a central node in accordance with one or more embodiments of the invention.

FIG. 2 shows a flowchart describing a method for federated learning in infrastructure domains in accordance with one or more embodiments of the invention.

FIG. 3 shows a flowchart describing a method for adaptive stochastic learning state compression in accordance with one or more embodiments of the invention.

FIG. 4 shows a flowchart describing a method for federated learning in infrastructure domains in accordance with one or more embodiments of the invention.

FIG. 5 shows an exemplary computing system in accordance with one or more embodiments of the invention.

FIG. 6 shows an exemplary neural network in accordance with one or more embodiments of the invention.

FIG. 7 shows exemplary distributions in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

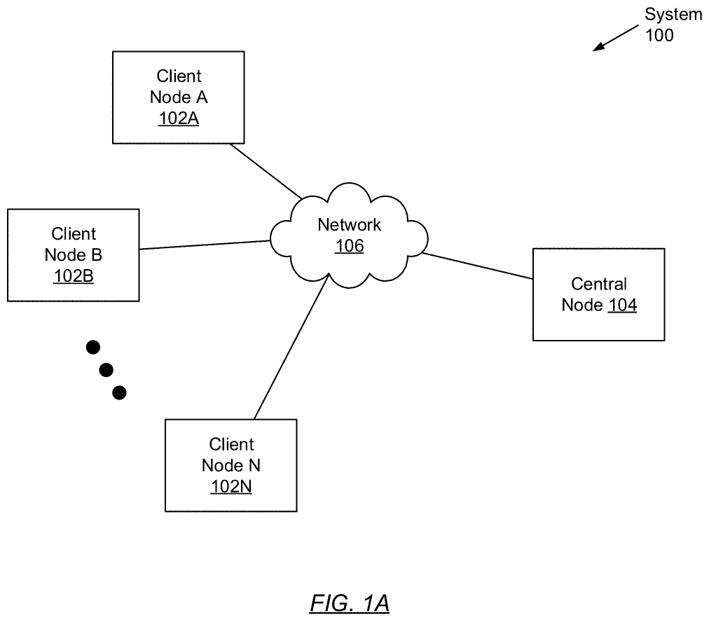

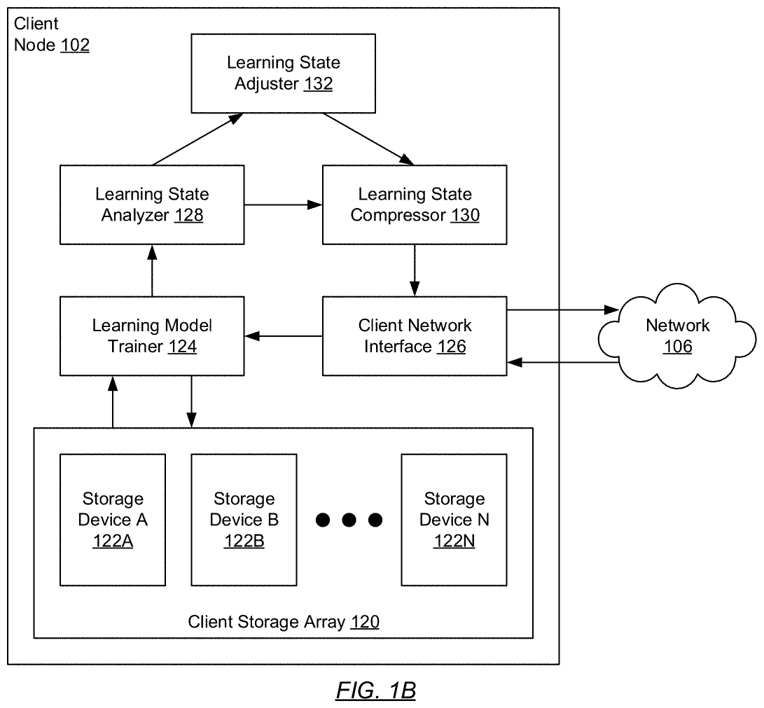

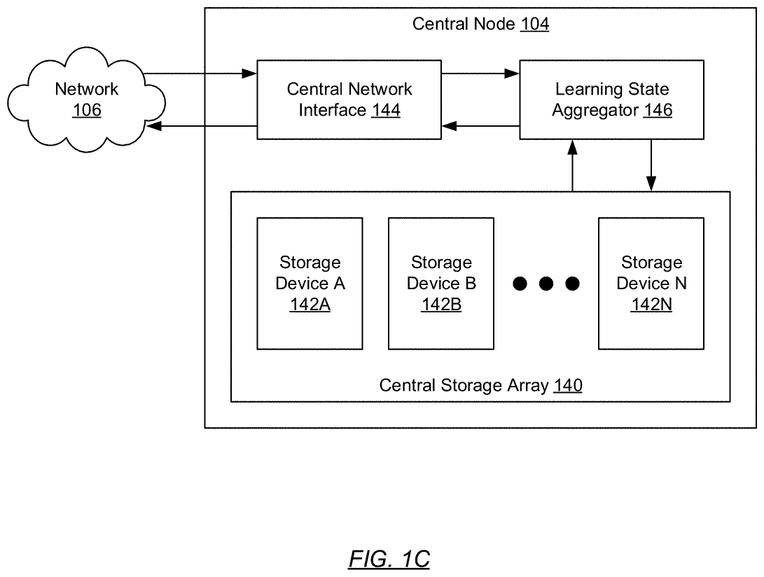

In the following description of FIGS. 1A-7, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to adaptive stochastic learning state compression for federated learning in infrastructure domains. Specifically, one or more embodiments of the invention introduce an adaptive data compressor directed to reducing the amount of information exchanged between nodes participating in the optimization of a shared machine learning model through federated learning. The adaptive data compressor may employ stochastic k-level quantization, and may include functionality to handle exceptions stemming from the detection of unbalanced and/or irregularly sized data.

FIG. 1A shows a system in accordance with one or more embodiments of the invention. The system (100) may represent an enterprise information technology (IT) infrastructure domain, which may entail composite hardware, software, and networking resources, as well as services, directed to the implementation, operation, and management thereof. The system (100) may include, but is not limited to, two or more client nodes (102A-102N) operatively connected to a central node (104) through a network (106). Each of these system (100) components is described below.

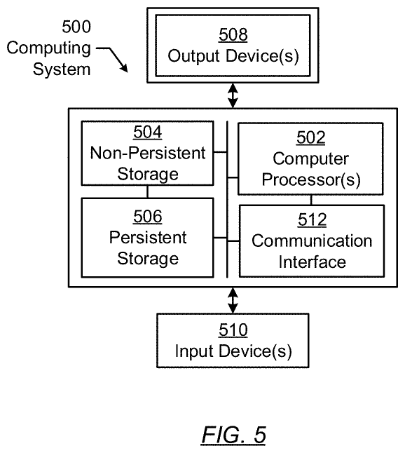

In one embodiment of the invention, a client node (102A-102N) may represent any physical appliance or computing system configured to receive, generate, process, store, and/or transmit data, as well as to provide an environment in which one or more computer programs may execute thereon. The computer program(s) may, for example, implement large-scale and complex data processing; or implement one or more services offered locally or over the network (106). Further, any subset of the computer program(s) may employ or invoke machine learning and/or artificial intelligence to perform their respective functions and, accordingly, may participate in federated learning (described below). In providing an execution environment for the computer program(s) installed thereon, a client node (102A-102N) may include and allocate various resources (e.g., computer processors, memory, storage, virtualization, networking, etc.), as needed, to the computer program(s) and the tasks instantiated thereby. One of ordinary skill will appreciate that a client node (102A-102N) may perform other functionalities without departing from the scope of the invention. Examples of a client node (102A-102N) may include, but are not limited to, a desktop computer, a workstation computer, a server, a mainframe, a mobile device, or any other computing system similar to the exemplary computing system shown in FIG. 5. Client nodes (102A-102N) are described in further detail below with respect to FIG. 1B.

In one embodiment of the invention, federated learning (also known as collaborative learning) may refer to the optimization (i.e., training and/or validation) of machine learning models using decentralized data. In traditional machine learning methodologies, the training and/or validation data, pertinent for optimizing learning models, are often stored centrally on a single device, datacenter, or the cloud. Through federated learning, however, the training and/or validation data may be stored across various devices (i.e., client nodes (102A-102N))—with each device performing a local optimization of a shared learning model using their respective local data. Updates to the shared learning model, derived differently on each device based on different local data, may subsequently be forwarded to a federated learning coordinator (i.e., central node (104)), which aggregates and applies the updates to improve the shared learning model.

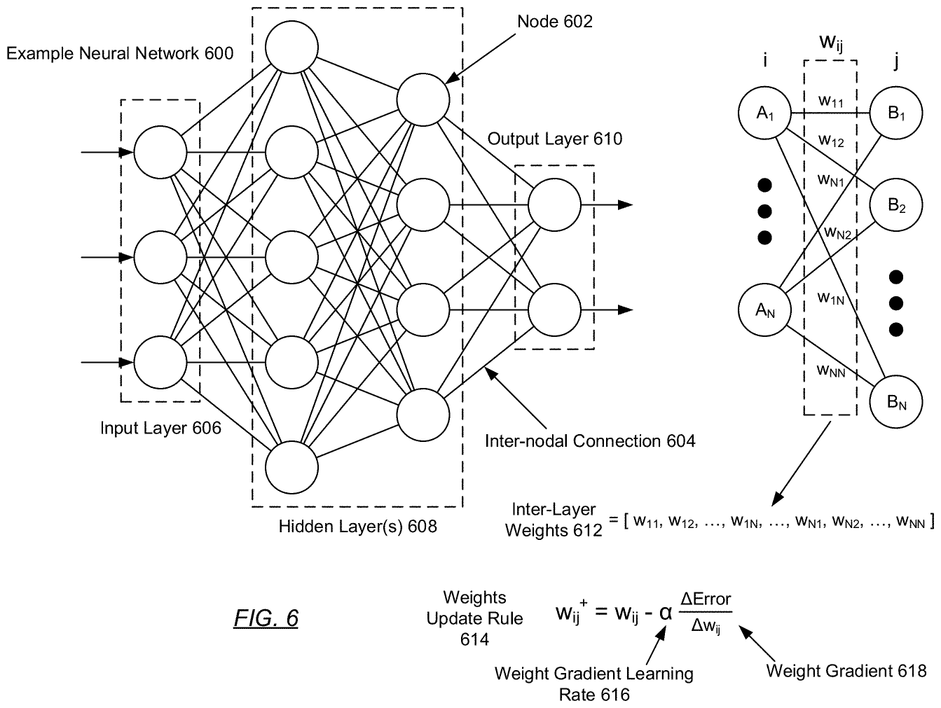

In one embodiment of the invention, a learning model may generally refer to a machine learning and/or artificial intelligence algorithm configured for classification and/or prediction applications. A learning model may further encompass any learning algorithm capable of self-improvement through the processing of sample (e.g., training and/or validation) data, which may also be referred to as a supervised learning algorithm. An example of a learning model, aspects of which may be predominantly mentioned throughout this disclosure as they pertain to embodiments of the invention, is the neural network. A neural network (described in further detail in FIG. 6) may represent a connectionist system, or a collection of interconnected nodes, which may loosely model the neurons and synapses between neurons in a biological brain. Embodiments of the invention are not limited to the employment of neural networks; other supervised learning algorithms (e.g., support vector machines) may be used without departing from the scope of the invention.

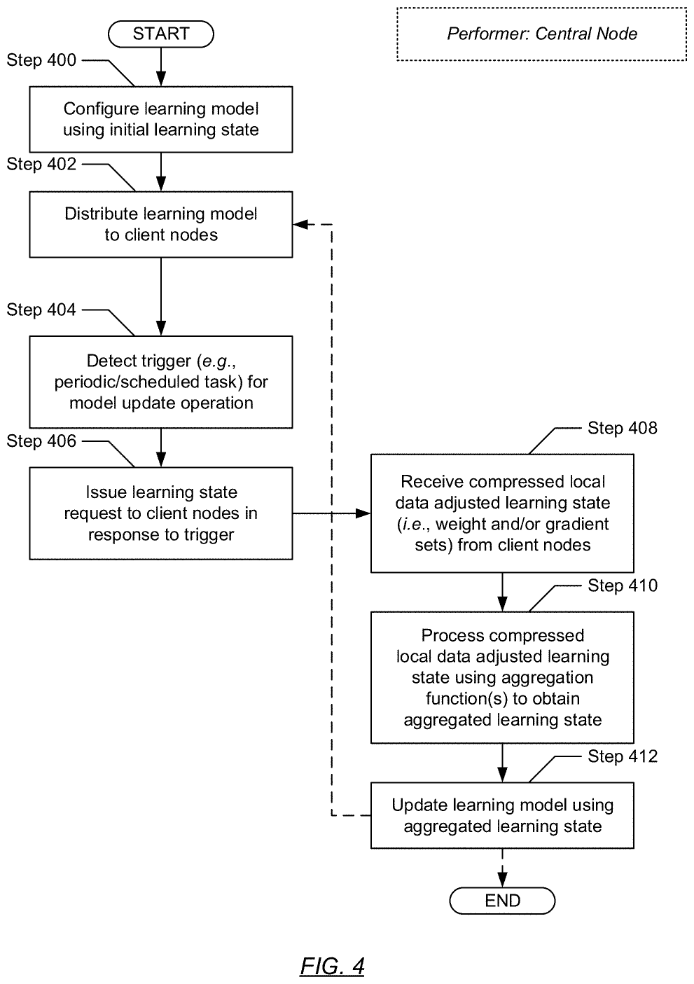

In one embodiment of the invention, the central node (104) may represent any physical appliance or computing system configured for federated learning (described above) coordination. By federated learning coordination, the central node (104) may include functionality to perform the various steps of the method described in FIG. 4, below. Further, one of ordinary skill will appreciate that the central node (104) may perform other functionalities without departing from the scope of the invention. Moreover, the central node (104) may be implemented using one or more servers (not shown). Each server may represent a physical or virtual server, which may reside in a datacenter or a cloud computing environment. Additionally or alternatively, the central node (104) may be implemented using one or more computing systems similar to the exemplary computing system shown in FIG. 5. The central node (104) is described in further detail below with respect to FIG. 1C.

In one embodiment of the invention, the above-mentioned system (100) components may operatively connect to one another through the network (106) (e.g., a local area network (LAN), a wide area network (WAN) such as the Internet, a mobile network, any other network type, or a combination thereof). The network (106) may be implemented using any combination of wired and/or wireless connections. Further, the network (106) may encompass various interconnected, network-enabled subcomponents (or systems) (e.g., switches, routers, gateways, etc.) that may facilitate communications between the above-mentioned system (100) components. Moreover, the above-mentioned system (100) components may communicate with one another using any combination of wired and/or wireless communication protocols.

While FIG. 1A shows a configuration of components, other system (100) configurations may be used without departing from the scope of the invention. For example, the system (100) may include additional central nodes (not shown) operatively connected, via the network (106), to the client nodes (102A-102N). These additional central nodes may be deployed for redundancy.

FIG. 1B shows a client node in accordance with one or more embodiments of the invention. The client node (102) may include, but is not limited to, a client storage array (120), a learning model trainer (124), a client network interface (126), a learning state analyzer (128), a learning state compressor (130), and a learning state adjuster (132). Each of these client node (102) subcomponents is described below.

In one embodiment of the invention, the client storage array (120) may refer to a collection of one or more physical storage devices (122A-122N) on which various forms of digital data—e.g., local data (i.e., input and target data) pertinent to the training and/or validation of learning models—may be consolidated. Each physical storage device (122A-122N) may encompass non-transitory computer readable storage media on which data may be stored in whole or in part, and temporarily or permanently. Further, each physical storage device (122A-122N) may be implemented based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the client storage array (120) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, the above-mentioned local data (stored on the client storage array (120)) may, for example, include one or more collections of data—each representing tuples of feature-target data pertinent to optimizing a given learning model (not shown) deployed on the client node (102). Each feature-target tuple, of any given data collection, may refer to a finite ordered list (or sequence) of elements, including: a feature set; and one or more expected (target) classification or prediction values. The feature set may refer to an array or vector of values (e.g., numerical, categorical, etc.)—each representative of a different feature (i.e., measurable property or indicator) significant to the objective or application of the given learning model, whereas the expected classification/prediction value(s) (e.g., numerical, categorical, etc.) may each refer to a desired output of, upon processing of the feature set by, the given learning model.

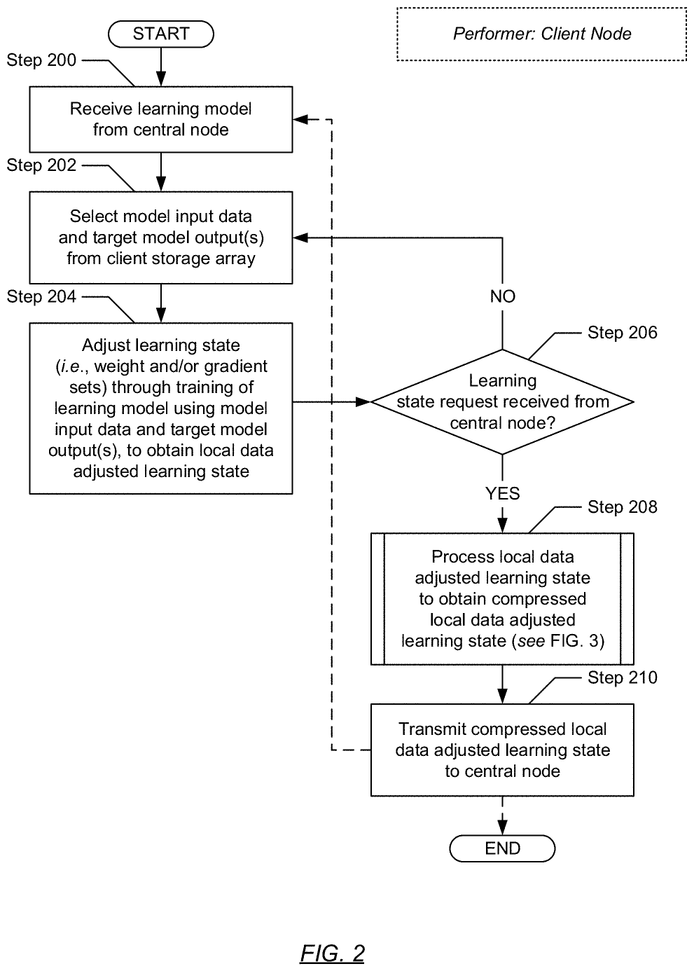

In one embodiment of the invention, the learning model trainer (124) may refer to a computer program that may execute on the underlying hardware of the client node (102). Specifically, the learning model trainer (124) may be responsible for optimizing (i.e., training and/or validating) one or more learning models (described above). To that extent, for any given learning model, the learning model trainer (124) may include functionality to: select local data (described above) pertinent to the given learning model from the client storage array (120); process the selected local data using the given learning model to adjust learning state (described below) of, and thereby optimize, the given learning model; repeat the aforementioned functionalities for the given learning model until a learning state request is received from the central node; and, upon receiving the learning state request, provide the latest local data adjusted learning state to the learning state analyzer (128) for processing. Further, one of ordinary skill will appreciate that the learning model trainer (124) may perform other functionalities without departing from the scope of the invention. Learning model optimization (i.e., training and/or validation) is described in further detail below with respect to FIG. 2.

In one embodiment of the invention, the above-mentioned learning state may refer to one or more factors pertinent to the automatic improvement (or “learning”) of a learning model through experience—e.g., through iterative optimization using various sample training and/or validation data, which may also be known as supervised learning. The aforementioned factor(s) may differ depending on the design, configuration, and/or operation of the learning model. For a neural network based learning model (see e.g., FIG. 6), for example, the factor(s) may include, but is/are not limited to: weights representative of the connection strengths between pairs of nodes structurally defining the neural network; weight gradients representative of the changes or updates applied to the weights during optimization based on output error of the neural network; and/or a weight gradients learning rate defining the speed at which the neural network updates the weights.

In one embodiment of the invention, the client network interface (126) may refer to networking hardware (e.g., network card or adapter), a logical interface, an interactivity protocol, or any combination thereof, which may be responsible for facilitating communications between the client node (102) and at least the central node (not shown) via the network (106). To that extent, the client network interface (126) may include functionality to: receive learning models (shared via federated learning) from the central node; provide the learning models for optimization to the learning model trainer (124); receive learning state requests from the central node; following notification of the learning state requests to the learning model trainer (124), obtain compressed learning state from the learning state compressor (130); and transmit the compressed learning state to the central node in response to the learning state requests. Further, one of ordinary skill will appreciate that the client network interface (126) may perform other functionalities without departing from the scope of the invention.

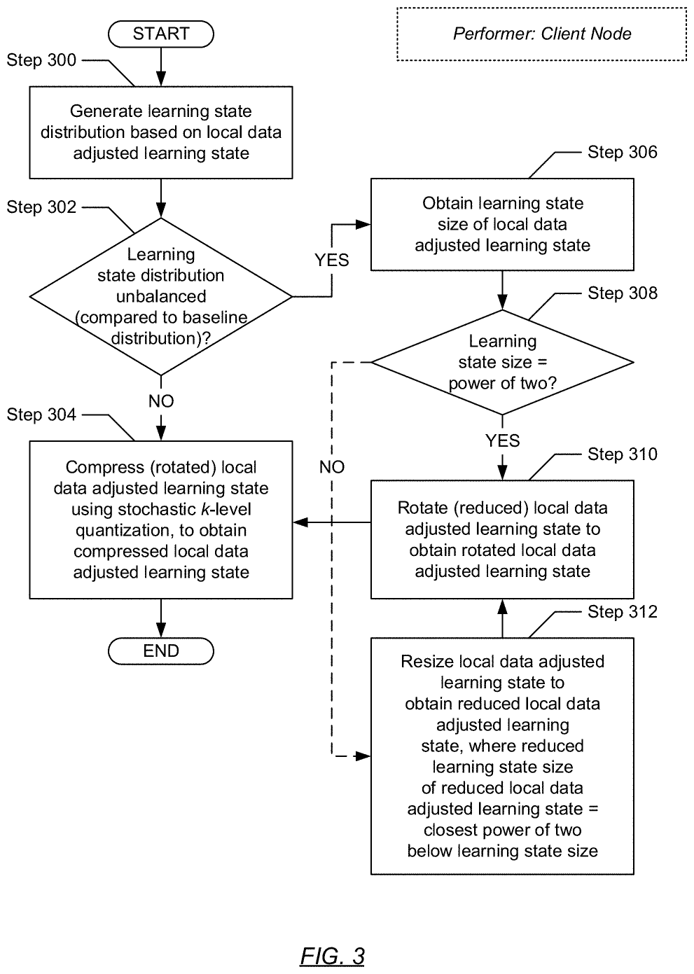

In one embodiment of the invention, the learning state analyzer (128) may refer to a computer program that may execute on the underlying hardware of the client node (102). Specifically, the learning state analyzer (128) may be responsible for learning state distribution analysis. To that extent, the learning state analyzer (128) may include functionality to: obtain local data adjusted learning state for a given learning model from the learning model trainer (124) upon receipt of learning state requests from the central node; generate learning state distributions based on the obtained local data adjusted learning state; analyze the generated learning state distributions, in view of a baseline distribution, to determine whether a learning state distribution is balanced or unbalanced; and provide the local data adjusted learning state to the learning state compressor (130) if the learning state distribution is determined to be balanced, or the learning state adjuster (132) if the learning state distribution is alternatively determined to be unbalanced. Further, one of ordinary skill will appreciate that the learning state analyzer (128) may perform other functionalities without departing from the scope of the invention. Learning state distributions are described in further detail below with respect to FIG. 3.

In one embodiment of the invention, the learning state compressor (130) may refer to a computer program that may execute on the underlying hardware of the client node (102). Specifically, the learning state compressor (130) may be responsible for learning state compression. To that extent, the learning state compressor (130) may include functionality to: obtain local data adjusted learning state from the learning state analyzer (128) or rotated local data adjusted learning state from the learning state adjuster (132); compress the obtained local data adjusted learning state (or rotated local data adjusted learning state) using stochastic k-level quantization, resulting in compressed local data adjusted learning state; and providing the compressed local data adjusted learning state to the client network interface (126) for transmission to the central node over the network (106). Further, one of ordinary skill will appreciate that the learning state compressor (130) may perform other functionalities without departing from the scope of the invention. Learning state compression using stochastic k-level quantization is described in further detail below with respect to FIG. 3.

In one embodiment of the invention, the learning state adjuster (132) may refer to a computer program that may execute on the underlying hardware of the client node (102). Specifically, the learning state adjuster (132) may be responsible for learning state adjustments necessary for proper compression. To that extent, the learning state adjuster (132) may include functionality to: obtain local data adjusted learning state for a given learning model from the learning state analyzer (128); assess the obtained local data adjusted learning state to determine a size thereof; resize the local data adjusted learning state if the size of the local data adjusted learning state fails to match a power of two (2ⁿ, n>1) value, thereby resulting in reduced local data adjusted learning state; rotate the local data adjusted learning state (or the reduced local data adjusted learning state) using Walsh-Hadamard transforms, resulting in rotated local data adjusted learning state; and providing the rotated local data adjusted learning state to the learning state compressor (130) for further processing. Further, one of ordinary skill will appreciate that the learning state adjuster (132) may perform other functionalities without departing from the scope of the invention. Learning state adjustment is described in further detail below with respect to FIG. 3.

While FIG. 1B shows a configuration of subcomponents, other client node (102) configurations may be used without departing from the scope of the invention.

FIG. 1C shows a central node in accordance with one or more embodiments of the invention. The central node (104) may include, but is not limited to, a central storage array (140), a central network interface (144), and a learning state aggregator (146). Each of these central node (104) subcomponents is described below.

In one embodiment of the invention, the central storage array (140) may refer to a collection of one or more physical storage devices (142A-142N) on which various forms of digital data—e.g., learning models (described above) (see e.g., FIG. 1B) and aggregated learning state—may be consolidated. Each physical storage device (142A-142N) may encompass non-transitory computer readable storage media on which data may be stored in whole or in part, and temporarily or permanently. Further, each physical storage device (142A-142N) may be implemented based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the central storage array (140) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, the central network interface (144) may refer to networking hardware (e.g., network card or adapter), a logical interface, an interactivity protocol, or any combination thereof, which may be responsible for facilitating communications between the central node (104) and one or more client nodes (not shown) via the network (106). To that extent, the central network interface (144) may include functionality to: obtain learning models from the learning state aggregator (146); distribute (i.e., transmit) the obtained learning models to the client node(s) for optimization (i.e., training and/or validation); issue learning state requests to the client node(s) upon detection of triggers directed to learning model update operations; in response to the issuance of the learning state requests, receive compressed local data adjusted learning state from each of the client node(s); and providing the compressed local data adjusted learning state to the learning state aggregator (146) for processing. Further, one of ordinary skill will appreciate that the central network interface (144) may perform other functionalities without departing from the scope of the invention.

In one embodiment of the invention, the learning state aggregator (146) may refer to a computer program that may execute on the underlying hardware of the central node (104). Specifically, the learning state aggregator (146) may be responsible for learning model configuration and improvement. To that extent, the learning state aggregator (146) may include functionality to: configure learning models using/with initial learning state; provide the configured learning models to the central network interface (144) for dissemination to the client node(s); obtain compressed local data adjusted learning state from the client node(s), via the central network interface (144), following the issuance of learning state requests thereto; process the compressed local data adjusted learning state, thereby resulting in aggregated learning state; update the learning models using the aggregated learning state; and provide the updated learning models to the central network interface (144) for dissemination to the client node(s). Further, one of ordinary skill will appreciate that the learning state aggregator (146) may perform other functionalities without departing from the scope of the invention. Aggregation of the learning state from the client node(s) is described in further detail below with respect to FIG. 3.

While FIG. 1C shows a configuration of subcomponents, other central node (104) configurations may be used without departing from the scope of the invention.

FIG. 2 shows a flowchart describing a method for federated learning in infrastructure domains in accordance with one or more embodiments of the invention. The various steps outlined below may be performed by a client node (see e.g., FIGS. 1A and 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 2, in Step 200, a learning model is received from the central node (see e.g., FIG. 1A). In one embodiment of the invention, the learning model may represent a machine learning and/or artificial intelligence algorithm configured for classification and/or prediction applications. The learning model may, for example, take form as a neural network (see e.g., FIG. 6). Further, the learning model may be configured with an initial learning state. The initial learning state may encompass default values for one or more factors (e.g., weights, weight gradients, and/or weight gradients learning rate) pertinent to the automatic improvement (or “learning”) of the learning model through experience.

In Step 202, local data, pertinent to the learning model (received in Step 200), is selected from storage. In one embodiment of the invention, the local data may include a collection of feature-target data tuples. Each feature-target tuple may encompass a feature set (i.e., values pertaining to a set of measurable properties or indicators) and one or more expected (or target) classification and/or prediction values representative of the desired output(s) of the learning model given the feature set. The feature set and expected classification/prediction value(s) may be significant to the objective or application for which the learning model may have been designed and/or configured.

In Step 204, the learning state of the learning model is adjusted using the local data (or collection of feature-target data tuples) (selected in Step 202). Specifically, in one embodiment of the invention, the collection of feature-target data tuples may first be partitioned into two feature-target data tuple subsets. Thereafter, the learning model may be trained using a first feature-target data tuple subset (i.e., a learning model training set), which may result in the optimization of one or more learning model parameters. A learning model parameter may refer to a model configuration variable that may be adjusted (or optimized) during a training runtime (or epoch) of the learning model. By way of examples, learning model parameters, pertinent to a neural network based learning model (see e.g., FIG. 6), may include, but are not limited to: the weights representative of the connection strengths between pairs of nodes structurally defining the model; and the weight gradients representative of the changes or updates applied to the weights during optimization based on output error of the neural network.

Following the above-mentioned training stage, the learning model may subsequently be validated using a second feature-target data tuple subset (i.e., a learning model testing set), which may result in the optimization of one or more learning model hyper-parameters. A learning model hyper-parameter may refer to a model configuration variable that may be adjusted (or optimized) before or between training runtimes (or epochs) of the learning model. By way of examples, learning model hyper-parameters, pertinent to a neural network based learning model (see e.g., FIG. 6), may include, but are not limited to: the number of hidden node layers and, accordingly, the number of nodes in each hidden node layer, between the input and output layers of the model; the activation function(s) used by the nodes of the model to translate their respective inputs to their respective outputs; and the weight gradients learning rate defining the speed at which the neural network updates the weights.

In one embodiment of the invention, adjustments to the learning state, through the above-described manner, may transpire until the learning model training and testing sets are exhausted, a threshold number of training runtimes (or epochs) is reached, or an acceptable performance condition (e.g., threshold accuracy, threshold convergence, etc.) is met. Furthermore, following these adjustments, local data adjusted learning state may be obtained, which may represent learning state optimized based on (or using) the local data (selected in Step 202).

In Step 206, a determination is made as to whether a learning state request has been received from the central node. In one embodiment of the invention, if it is determined that the learning state request has been received, then the process proceeds to Step 208. On the other hand, in another embodiment of the invention, if it is alternatively determined that the learning state request has yet to be received, then the process alternatively proceeds to Step 202. Following the latter determination, local data, pertinent to the learning model, may be selected from storage and used in another iteration of adjustments to the learning state.

In Step 208, following the determination (in Step 206) that a learning state request has been received from the central node, the local data adjusted learning state (obtained in Step 204) is processed. In one embodiment of the invention, processing of the local data adjusted learning state may result in the obtaining of compressed local data adjusted learning state—details of which are described in FIG. 3, below.

In Step 210, the compressed local data adjusted learning state (obtained in Step 208) is transmitted to the central node. In one embodiment of the invention, transmission of the compressed local data adjusted learning state may transpire in response to the learning state request (determined to have been received in Step 206). Following the transmission, another learning model may or may not be received from the central node. Should another learning model be received, the new learning model may be configured using/with aggregated learning state, which may encompass non-default values for one or more factors (e.g., weights, weight gradients, and/or weight gradients learning rate) pertinent to the automatic improvement (or “learning”) of the learning model through experience. These non-default values may be derived from the computation of summary statistics (e.g., averaging) on the different compressed local data adjusted learning state, received by the central node, from the various client nodes.

FIG. 3 shows a flowchart describing a method for adaptive stochastic learning state compression in accordance with one or more embodiments of the invention. The various steps outlined below may be performed by a client node (see e.g., FIGS. 1A and 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 3, in Step 300, a learning state distribution is generated. In one embodiment of the invention, the learning state distribution may represent an empirical distribution of the local data adjusted learning state. The local data adjusted learning state—in context to a neural network based learning model, for example, may include, but is not limited to: a weights tuple, including a series of weight values, for each pair of successive layers of at least two layers (i.e., input and output layers) defining the neural network (see e.g., FIG. 6); a weight gradients tuple, including a series of weight gradient values, for each pair of successive layers of at least two layers defining the neural network; and/or a weight gradients learning rate value for each pair of successive layers of at least two layers defining the neural network. Further, the learning state distribution may reflect a density plot of the local data adjusted learning state values. Generally, a density plot may visualize the distribution of data over a continuous time interval, and may represent a variation of a histogram that uses kernel smoothing to plot the peak values thereof.

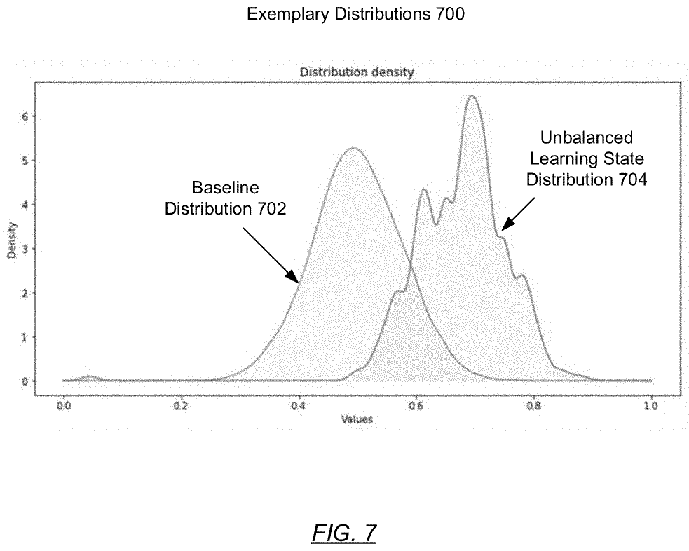

In Step 302, a determination is made as to whether the learning state distribution (generated in Step 300) is unbalanced. The determination may entail comparing the learning state distribution to a baseline distribution (described below). Further, the comparison may involve computing a distribution divergence there-between. Computation of the distribution divergence may employ any existing relative entropy algorithm such as, for example, the Kullback-Leibler divergence algorithm or the Jensen-Shannon divergence algorithm Thereafter, the computed distribution divergence may be compared against a predefined distribution divergence threshold. An exemplary unbalanced learning state distribution versus an exemplary baseline distribution are shown in FIG. 7, below.

In one embodiment of the invention, the above-mentioned baseline distribution may represent a balanced distribution of the learning state, which may be assembled in varying ways. By way of an example, the baseline distribution may be generated as a continuous uniform distribution defined by the minimum and maximum values of the local data adjusted learning state. By way of another example, the baseline distribution may be generated as a Gaussian (normal) distribution defined by the mean and standard deviation of the local data adjusted learning state values.

Returning to the determination, in one embodiment of the invention, if it is determined that the computed distribution divergence meets (or exceeds) the distribution divergence threshold, then the learning state distribution (generated in Step 300) is found to be unbalanced and, accordingly, the process proceeds to Step 306. On the other hand, in another embodiment of the invention, if it is alternatively determined that the computed distribution divergence fails to at least meet the distribution divergence threshold, then the learning state distribution is found to be balanced and, accordingly, the process alternatively proceeds to Step 304.

In Step 304, the local data adjusted learning state (or a rotated local data adjusted learning state) is compressed, thereby resulting in the attainment of compressed local data adjusted learning state. That is, in one embodiment of the invention, following the determination (in Step 302) that the learning state distribution (generated in Step 300) is balanced, the local data adjusted learning state is compressed. Alternatively, in another embodiment of the invention, the rotated local data adjusted learning state (obtained in Step 310) (described below) is compressed.

Nevertheless, in either of the above-mentioned embodiments, compression may be performed using stochastic k-level quantization. Through stochastic k-level quantization, the learning state (i.e., local data adjusted learning state or rotated local data adjusted learning state) may be encoded using much fewer bits of information, thereby reducing communication costs associated with the transmission of the learning state to the central node. The methodology for performing stochastic k-level quantization, in accordance with one or more embodiments of the invention, is presented below.

Methodology for Stochastic k-Level Quantization

For a given uncompressed learning state (e.g., weights, weight gradients, and/or weight gradients learning rate) vector of values X:
1. Identify the vector minimum Xₘᵢₙ and the vector maximum Xₘₐₓ
2. Select number of quantization levels k, where k is a positive integer larger than 1, where k specifies the desired number of intervals used to encode each vector value
3. Determine quantization steps l(i)=Xₘᵢₙ+i·s for i∈[0, k−1], where

$$s = \frac{( {X}_{max} - {X}_{min} )}{k - 1}$$

4. Derive compressed learning state vector of values Y for a given X(j)/l(i)<X(j)≤l(i+1), where j∈[1, n], where n specifies the number of values (or length) of X:

$$Y ( j ) = \{ \begin{matrix}l ( i + 1 ) & w . p . \frac{X ( j ) - l ( i )}{l ( i + 1 ) - l ( i )} \\ l ( i ) & otherwise\end{matrix}$$

In one embodiment of the invention, through stochastic k-level quantization, the amount of information (i.e., representative of the compressed local data adjusted learning state) transmitted to the central node may be reduced to ┌log₂ k┐·n bits, and two floats (e.g., 32 bits each) for Xₘᵢₙ and Xₘₐₓ.

In Step 306, following the alternative determination (in Step 302) that the learning state distribution (generated in Step 300) is unbalanced, a learning state size is obtained. In one embodiment of the invention, the learning state size may refer to the number of values (or length) representative of the local data adjusted learning state.

In Step 308, a determination is made as to whether the learning state size (obtained in Step 306) is a power-of-two value. A power-of-two value may refer to a number of the form 2^{m}, where m specifies a positive integer (i.e., m>0). Accordingly, in one embodiment of the invention, if it is determined that the learning state size is a power-of-two value, then the process proceeds to Step 310. On the other hand, in another embodiment of the invention, if it is alternatively determined that the learning state size is not a power-of-two value, then the process alternatively proceeds to Step 312.

In Step 310, the local data adjusted learning state (or a reduced local data adjusted learning state) is rotated, thereby resulting in the attainment of rotated local data adjusted learning state. That is, in one embodiment of the invention, following the determination (in Step 308) that the learning state size (obtained in Step 306) is a power-of-two value, the local data adjusted learning state is rotated. Alternatively, in another embodiment of the invention, the reduced local data adjusted learning state (obtained in Step 312) (described below) is rotated.

In one embodiment of the invention, rotation of the learning state (i.e., local data adjusted learning state or reduced local data adjusted learning state) may employ the Walsh-Hadamard transform (WHT). The WHT is a Fourier-related transform, which may exhibit interesting characteristics, such as the reduction of imbalance between dimensions. With respect to the rotation of a vector X, the WHT may be applied as follows:

Z=RX;X=R⁻¹Z;R=HD

where: Z represents the resulting (rotated) vector, R represents a rotation matrix, H represents a Walsh-Hadamard matrix, and D represents a stochastic diagonal matrix including Rademarcher entries of ±1 with probability of 0.5. Further, the Walsh-Hadamard matrix H may have the following law of formation:

$$H ( {2}^{1} ) = [ \begin{matrix}1 & 1 \\ 1 & - 1\end{matrix} ] ; H ( {2}^{m} ) = [ \begin{matrix}H ( {2}^{m - 1} ) & H ( {2}^{m - 1} ) \\ H ( {2}^{m - 1} ) & H ( {2}^{m - 1} )\end{matrix} ]$$

From Step 310, the process proceeds to Step 304, where the rotated local data adjusted learning state may be subjected to compression using stochastic k-level quantization (described above).

In Step 312, following the alternative determination (in Step 308) that the learning state size (obtained in Step 306) is not a power-of-two value, the local data adjusted learning state is resized. Specifically, in one embodiment of the invention, a number of values, in part, representing the local data adjusted learning state may be discarded therefrom, thereby resulting in a reduced local data adjusted learning state. A reduced learning state size of (or number of remaining values in) the reduced local data adjusted learning state may equate to a closest power-of-two value under the learning state size. For example, if the learning state size were 312 (i.e., reflective that the local data adjusted learning state includes 312 values), the reduced learning state size may be 256 (i.e., reflective that the reduced local data adjusted learning state would include 256 of the 312 values).

Further, in one embodiment of the invention, the above-mentioned discarded value(s) of the local data adjusted learning state may be selected at random. In another embodiment of the invention, the value(s) chosen to remain, thereby forming the reduced local data adjusted learning state, may be determined through a stochastic approach. More specifically, each value of the local data adjusted learning state may be assigned a selection probability, which may be proportional to the absolute value of the value. From Step 312, the process proceeds to Step 310, where the reduced local data adjusted learning state may be subjected to rotation using the WHT (described above).

FIG. 4 shows a flowchart describing a method for federated learning in infrastructure domains in accordance with one or more embodiments of the invention. The various steps outlined below may be performed by a central node (see e.g., FIGS. 1A and 1C). Further, while the various steps in the flowchart are presented and described sequentially, one of ordinary skill will appreciate that some or all steps may be executed in different orders, may be combined or omitted, and some or all steps may be executed in parallel.

Turning to FIG. 4, in Step 400, a learning model is configured. In one embodiment of the invention, the learning model may represent a machine learning and/or artificial intelligence algorithm configured for classification and/or prediction applications. The learning model may, for example, take form as a neural network (see e.g., FIG. 6). Further, the learning model may be configured with an initial learning state. The initial learning state may encompass default values for one or more factors (e.g., weights, weight gradients, and/or weight gradients learning rate) pertinent to the automatic improvement (or “learning”) of the learning model through experience.

In Step 402, the learning model (configured in Step 400) is distributed to the various client nodes. In Step 404, a trigger for a model update operation is detected. In one embodiment of the invention, the model update operation may reference the task of learning state aggregation as required, in part, by federated learning (described above) (see e.g., FIG. 1A). Further, the trigger may manifest, for example, upon the elapsing of a specified interval of time since the distribution of the learning model (in Step 402). The aforementioned interval of time may allow the various client nodes sufficient time to optimize the learning model using their respective local data through several training iterations (or epochs).

In Step 406, in response to the trigger (detected in Step 404), learning state requests are issued to the various client nodes. Thereafter, in Step 408, compressed local data adjusted learning state is received from each client node. In one embodiment of the invention, the compressed local data adjusted learning state, from a given client node, may refer to learning state that has been optimized based on (or using) the local data, pertinent to the learning model, available on the given client node; and may further refer to learning state that has been compressed through stochastic k-level quantization (described above) (see e.g., FIG. 3).

In Step 410, the compressed local data adjusted learning state from each client node (received in Step 408) is processed. Specifically, in one embodiment of the invention, summary statistics (e.g., averaging) may be applied over the various compressed local data adjusted learning state, thereby resulting in the attainment of aggregated learning state. In Step 412, the learning model (configured in Step 400) is updated using the aggregated learning state (obtained in Step 410). More specifically, in one embodiment of the invention, the existing learning state of the learning model may be replaced with the aggregated learning state. Through this replacement of learning state, a new learning model may be obtained. Thereafter, the aforementioned new learning model may or may not be distributed to the various client nodes for further optimization.

FIG. 5 shows an exemplary computing system in accordance with one or more embodiments of the invention. The computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a central processing unit (CPU) and/or a graphics processing unit (GPU). The computing system (500) may also include one or more input devices (510), such as a touchscreen, keyboard, mouse, microphone, touchpad, electronic pen, or any other type of input device. Further, the communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

In one embodiment of the invention, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

FIG. 6 shows an exemplary neural network in accordance with one or more embodiments of the invention. As mentioned above in FIG. 1A, an example of a learning model, aspects of which may be predominantly mentioned throughout this disclosure as they pertain to embodiments of the invention, is the neural network (600). A neural network (600) may represent a connectionist system, or a collection of interconnected nodes, which may loosely model the neurons and synapses between neurons in a biological brain. Like any network, a neural network (600) may reflect a hierarchy (or organization) of elements. These elements, in the case of a neural network (600), may be referred to as nodes (602), which function as small computing processors capable of deriving outputs from the summation of input-weight products through an activation function. The hierarchy presented in a neural network (600) may manifest as stacked layers (or rows) of these nodes (602). Any given neural network (600) may include two or more layers—i.e., an input layer (606), an output layer (610), and zero or more hidden layers (608) disposed between the input and output layers (606, 610). One or many nodes (602) may be used to form each layer.

Furthermore, any given node (602) in a neural network (600) may link to one or more other nodes (602) of a preceding layer (if any) and/or one or more other nodes (602) of a succeeding layer (if any). Each of these links may be referred to as an inter-nodal connection (or just connection) (604). Each connection (604) may be associated with a coefficient or weight, which may assign a strength to any input received via the connection. The weight may either amplify or dampen the respective input, thereby providing a significance to the input with respect to the output of a succeeding node (602) and, eventually, the overall objective—e.g., classification or prediction—of the neural network (600).

Moreover, these weights, throughout a neural network (600), may be updated iteratively during optimization (i.e., training and/or validation) of the neural network (600). Specifically, during optimization, each set of weights—i.e., inter-layer weights (612)—respective to connections (604) between nodes (602) of two successive layers may be updated using a weights update rule (614). The weights update rule (614), at least exemplified here, is based on the principle of gradient descent, which makes adjustments to the weights using a product of a weight gradient learning rate (616) and a weight gradient (618). The weight gradient learning rate (616) may refer to the speed at which the neural network (600) updates the weights, and/or the importance of the impact of the weight gradient (618) on the weights. Meanwhile, the weight gradient (618) may reference a local minimum (i.e., first derivative) of a loss function with respect to the weight. The loss function may measure the error between the target output and actual output of the neural network (600) given target-corresponding input data.

The various forms of learning state described throughout this disclosure may fundamentally include: a weights tuple (i.e., the inter-layer weights (612)), including a series of weight values, for each pair of successive layers defining the neural network (600); a weight gradients tuple, including a series of weight gradient values (i.e., the weight gradient (618)), for each pair of successive layers defining the neural network (600); and/or the weight gradients learning rate (616) for each pair of successive layers defining the neural network (600). Learning state, again, may refer to one or more factors pertinent to the automatic improvement (or “learning”) of a learning model (e.g., the neural network (600)) through experience—e.g., through iterative optimization using various sample training and/or validation data, which may also be known as supervised learning.

FIG. 7 shows exemplary distributions in accordance with one or more embodiments of the invention. A distribution (700) may refer to a representation (e.g., list, table, function, graph, etc.) disclosing all the values (or intervals) of a dataset (e.g., learning state) and the frequency of occurrence thereof. Within the disclosure, learning state distributions are described to be used in the determination of whether the learning state is balanced or unbalanced in comparison to a baseline distribution (702). Subsequently, the determination may or may not trigger the rotation and/or resizing of the learning state prior to compression (see e.g., FIG. 3).

In one embodiment of the invention, a baseline distribution (702) may represent a balanced (or symmetric) distribution of a given learning state, which may be assembled in varying ways. By way of an example, the baseline distribution (702) may be generated as a continuous uniform distribution defined by the minimum and maximum values of the given learning state. By way of another example, the baseline distribution (702) may be generated as a Gaussian (normal) distribution defined by the mean and standard deviation of the given learning state. In contrast, the presented unbalanced learning state distribution (704) may exemplify an asymmetric or skewed representation of the values (and frequencies thereof) of a given learning state. Should a measured distribution divergence between the baseline distribution (702) for a given learning state and a learning state distribution for the given learning state meet or exceed a distribution divergence threshold, the latter may be designated as an unbalanced learning state distribution (704).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for decentralized learning model optimization, comprising:
receiving, by a client node and from a central node, a first learning model configured with an initial learning state;
adjusting the initial learning state through optimization of the first learning model using local data to obtain a local data adjusted learning state;
in response to receiving a learning state request from the central node:
processing the local data adjusted learning state at least using stochastic k-level quantization to obtain a compressed local data adjusted learning state; and
transmitting the compressed local data adjusted learning state to the central node.

2. The method of claim 1, wherein the first learning model is a neural network comprising a plurality of layers.

3. The method of claim 2, wherein the initial learning state comprises at least one selected from a group consisting of a weights tuple for each pair of successive layers of the plurality of layers, a weight gradients tuple for each pair of successive layers of the plurality of layers, and a weight gradients learning rate for each pair of successive layers of the plurality of layers.

4. The method of claim 1, wherein processing the local data adjusted learning state, comprises:
generating a learning state distribution based on the local data adjusted learning state;
making a determination that the learning state distribution is balanced; and
compressing, based on the determination, the local data adjusted learning state using the stochastic k-level quantization to obtain the compressed local data adjusted learning state.

5. The method of claim 4, wherein making the determination, comprises:
computing a distribution divergence between the learning state distribution and a baseline distribution,
wherein the distribution divergence fails to meet a distribution divergence threshold.

6. The method of claim 1, wherein processing the local data adjusted learning state, comprises:
generating a learning state distribution based on the local data adjusted learning state;
making a first determination that the learning state distribution is unbalanced;
making a second determination, based on the first determination, that a learning state size of the local data adjusted learning state is a power-of-two value;
rotating, based on the second determination, the local data adjusted learning state to obtain a rotated local data adjusted learning state; and
compressing the rotated local data adjusted learning state using the stochastic k-level quantization to obtain the compressed local data adjusted learning state.

7. The method of claim 6, wherein making the first determination, comprises:
computing a distribution divergence between the learning state distribution and a baseline distribution,
wherein the distribution divergence at least meets a distribution divergence threshold.

8. The method of claim 6, wherein the local data adjusted learning state is rotated using a Walsh-Hadamard transform.

9. The method of claim 1, wherein processing the local data adjusted learning state, comprises:
generating a learning state distribution based on the local data adjusted learning state;
making a first determination that the learning state distribution is unbalanced;
making a second determination, based on the first determination, that a learning state size of the local data adjusted learning state is not a power-of-two value;
resizing, based on the second determination, the local data adjusted learning state to obtain a reduced local data adjusted learning state, wherein a reduced learning state size of the reduced local data adjusted learning state is a closest power-of-two value below the learning state size;
rotating the reduced local data adjusted learning state to obtain a rotated local data adjusted learning state; and
compressing the rotated local data adjusted learning state using the stochastic k-level quantization to obtain the compressed local data adjusted learning state.

10. The method of claim 1, further comprising:
receiving, by the client node and from the central node, a second learning model configured with an aggregated learning state,
wherein the aggregated learning state is derived from the compressed local data adjusted learning state and at least another compressed local data adjusted learning state from a second client node.

11. A non-transitory computer readable medium (CRM) comprising computer readable program code, which when executed by a computer processor on a client node, enables the computer processor to:
receive, from a central node, a first learning model configured with an initial learning state;
adjust the initial learning state through optimization of the first learning model using local data to obtain a local data adjusted learning state;
in response to receiving a learning state request from the central node:
process the local data adjusted learning state at least using stochastic k-level quantization to obtain a compressed local data adjusted learning state; and
transmit the compressed local data adjusted learning state to the central node.

12. The non-transitory CRM of claim 11, wherein the first learning model is a neural network comprising a plurality of layers.

13. The non-transitory CRM of claim 12, wherein the initial learning state comprises at least one selected from a group consisting of a weights tuple for each pair of successive layers of the plurality of layers, a weight gradients tuple for each pair of successive layers of the plurality of layers, and a weight gradients learning rate for each pair of successive layers of the plurality of layers.

14. The non-transitory CRM of claim 11, comprising computer readable program code to process the local data adjusted learning state, which when executed by the computer processor on the client node, enables the computer processor to:
generate a learning state distribution based on the local data adjusted learning state;
make a determination that the learning state distribution is balanced; and
compress, based on the determination, the local data adjusted learning state using the stochastic k-level quantization to obtain the compressed local data adjusted learning state.

15. The non-transitory CRM of claim 14, comprising computer readable program code to make the determination, which when executed by the computer processor on the client node, enables the computer processor to:
compute a distribution divergence between the learning state distribution and a baseline distribution,
wherein the distribution divergence fails to meet a distribution divergence threshold.

16. The non-transitory CRM of claim 11, comprising computer readable program code to process the local data adjusted learning state, which when executed by the computer processor on the client node, enables the computer processor to:
generate a learning state distribution based on the local data adjusted learning state;
make a first determination that the learning state distribution is unbalanced;
make a second determination, based on the first determination, that a learning state size of the local data adjusted learning state is a power-of-two value;
rotate, based on the second determination, the local data adjusted learning state to obtain a rotated local data adjusted learning state; and
compress the rotated local data adjusted learning state using the stochastic k-level quantization to obtain the compressed local data adjusted learning state.

17. The non-transitory CRM of claim 16, comprising computer readable program code to make the first determination, which when executed by the computer processor on the client node, enables the computer processor to:
compute a distribution divergence between the learning state distribution and a baseline distribution,
wherein the distribution divergence at least meets a distribution divergence threshold.

18. The non-transitory CRM of claim 16, wherein the local data adjusted learning state is rotated using a Walsh-Hadamard transform.

19. The non-transitory CRM of claim 11, comprising computer readable program code to process the local data adjusted learning state, which when executed by the computer processor on the client node, enables the computer processor to:
generate a learning state distribution based on the local data adjusted learning state;
make a first determination that the learning state distribution is unbalanced;
make a second determination, based on the first determination, that a learning state size of the local data adjusted learning state is not a power-of-two value;
resize, based on the second determination, the local data adjusted learning state to obtain a reduced local data adjusted learning state, wherein a reduced learning state size of the reduced local data adjusted learning state is a closest power-of-two value below the learning state size;
rotate the reduced local data adjusted learning state to obtain a rotated local data adjusted learning state; and
compress the rotated local data adjusted learning state using the stochastic k-level quantization to obtain the compressed local data adjusted learning state.

20. The non-transitory CRM of claim 11, comprising computer readable program code, which when executed by the computer processor on the client node, further enables the computer processor to:
receive, from the central node, a second learning model configured with an aggregated learning state,
wherein the aggregated learning state is derived from the compressed local data adjusted learning state and at least another compressed local data adjusted learning state from a second computer processor on a second client node.
